(19) United States
(12) Patent Application Publication
(10) Pub. No.: US 2010/0318218 A1
(43) Pub. Date: Dec. 16, 2010

(54) Pill Dispenser and Method

(76) Inventors: Robert B. Muncy, JR., Lexington, KY (US); William R. Dieter, Lexington, KY (US); Anthony J. McEldowney, Keystone Heights, FL (US); John T. Henninger, Lexington, KY (US); Richard R. Muse, Georgetown, KY (US); Bonnie L. Muse, Georgetown, KY (US)

Correspondence Address: KING & SCHICKLI, PLLC, 247 NORTH BROADWAY, LEXINGTON, KY, 40507, US

(21) Appl. No.: 12/815,666

(22) Filed: Jun. 15, 2010

Related U.S. Application Data
(60) Provisional application No. 61/187,042, filed on Jun. 15, 2009.

(51) Int. Cl. B65D 83/04; G06F 7/00; G06F 17/00

(52) U.S. Cl. 700/220; 221/123; 221/282; 221/199; 700/237

(57) ABSTRACT

Disclosed is a pill dispenser. In one embodiment, the pill dispenser includes a housing defining an interior. The dispenser may also include a holder for receiving a plurality of pills, a movable barrier positioned at one end of the holder, and a retainer capable of moving at least one of the pills in the holder. At least a portion of the holder and barrier may be positioned within the interior of the housing. Related methods are also disclosed.

This application claims the benefit of U.S. Provisional Patent Application Ser. No. 61/187,042, filed Jun. 15, 2009, herein incorporated by reference.

### TECHNICAL FIELD

The present application relates to a dispenser and; more specifically, a pill dispenser and method.

### BACKGROUND OF THE INVENTION

Prescription drug abuse is a widespread problem affecting people from all walks of life. In many instances, patients become addicted to narcotics that have been prescribed by their doctors to help them recover from surgery or other traumatic injury. Due to the addictive nature of many narcotics, patients may begin abusing the medication by taking it more frequently than the prescribed rate or in larger doses than prescribed. Such abuse can lead to severe medical problems for the abuser and can result in death, due to overdosing or extended exposure to the narcotics. Accordingly, physicians are often reluctant to prescribe narcotics to individuals who may need them. Moreover, many pharmacies do not stock certain narcotics for fear of diversion of the prescription medication to the illegal market.

Therefore, the need exists for a dispenser that includes safeguards to prevent the dispensing of pills at a rate faster and/or in a greater quantity than prescribed. Additional aspects, advantages and other novel features of the invention will be set forth in part in the description that follows and in part will become apparent to those skilled in the art upon examination of the foregoing or may be learned with the practice of the invention.

### SUMMARY OF THE INVENTION

In accordance with the purposes of the present invention as described herein, a new and improved pill dispenser and method are disclosed. One embodiment of the pill dispenser may comprise a housing defining an interior, a plurality of holders for receiving a plurality of pills, a movable barrier positioned at one end of the holder, and a retainer capable of moving at least one of the pills in the holder. In one embodiment, at least a portion of the holder and barrier may be positioned within the interior of the housing. The retainer may be connected to a spring and alignment of an aperture of the barrier enables the movement of a pill from the holder. The retainer may be self-leveling and include at least one flexible arm. The dispenser may further include gear wherein the barrier engages a portion of the gear. In one embodiment, rotation of the gear causes rotation of the barrier. The dispenser may include a motor for moving the gear. In one embodiment, the barrier includes an angled surface for directing the movement of a pill after it exits the holder. The barrier may include a disc with a plurality of detents and the holder includes a projection that interacts with at least one of the detents to control movement of the disc. The dispenser may also include a friction coupling between a lid and the gear to allow movement of the lid independent from the gear. The dispenser may also include a user interface with at least one input and one output. In one embodiment, at least one input is a button. At least one output may be a plurality of lights.

In accordance with another aspect of the invention, a pill dispenser is disclosed. The pill dispenser may comprise a housing defining an interior, a holder including at least one tube for receiving a plurality of pills, a rotatable disc having at least one aperture positioned at one end of the holder; and a pill compressor that is capable of moving at least one of the pills in at least one tube. In one embodiment, at least a portion of the holder and barrier are positioned within the interior of the housing and movement of the disc enables release of a pill from at least one tube. The pill dispenser may also include a gear wherein the rotatable engages a portion of the gear. The gear may include a plurality of teeth on an outer surface and the dispenser further includes a motor that engages at least a portion of the plurality of teeth. The holder may include a plurality of symmetrically positioned tubes. The pill compressor may include a plurality of arms to match the number of tubes. In one embodiment, the plurality of arms are flexible thereby self-leveling the pill compressor. The arms may also include a cylindrical member. A spring may retain the pill compressor to the holder. The dispenser may include a lid having at least one aperture. In one embodiment, the rotatable disc includes an angled surface that is capable of directing a pill to at least one aperture of the lid. The rotatable disc may include a plurality of detents or projections. The holder may include a projection that interacts with at least one of the detents or projections to control movement of the disc. The dispenser may include a friction coupling between a lid and the gear to allow movement of lid independent from the gear. In one embodiment, the dispenser includes a user interface with at least one input and one output. At least one input may be a button.

At least one output may be a plurality of lights.

In accordance with another aspect of the invention, a method of filling a pill dispenser is disclosed. The method may include accessing a software program, entering data relating to a prescription, connecting the pill dispenser with the software, programming the pill dispenser with data, and placing pills in the pill dispenser. In one embodiment, the method of filling further comprises sealing the pill dispenser. The accessing a software program may require user authentication to fully access the software program. The programming the pill dispenser may comprise storing a dispensing schedule. The connecting may comprise physically connecting the pill dispenser to a computer by a wire.

In accordance with another aspect of the invention, a method of dispensing pills is disclosed. The method may include determining if it is an appropriate time for dispensing a pill, authenticating the user in possession of a pill dispenser, and dispensing a pill from the pill dispenser, if the user is authenticated and it is an appropriate time for dispensing the pill. In one embodiment, the authenticating requires the user to enter a PIN. The pill dispenser may further compare the entered PIN to a PIN stored in the memory of the pill dispenser. The determining if it is an appropriate time for dispensing a pill may comprise determining if a programmed amount of time has passed since a previous pill was dispensed. The determining if it is an appropriate time for dispensing a pill may comprise determining if a programmed amount of time has passed since the device was programmed. The determining if it is an appropriate time for dispensing a pill may comprise determining if the device is undamaged. In one embodiment, the method includes the step of detecting tampering with the pill dispenser.

In accordance with another aspect of the invention, a pill dispenser is disclosed. The pill dispenser may comprise a housing defining an interior, a holder including a plurality of recesses for holding pills, and a movable barrier having an aperture that enables a pill to be released from the holder. In one embodiment, the holder includes a plurality of rings of apertures. The holder may include a channel and the moveable barrier includes a follower that engages the channel. The housing may include a first portion and a second portion and one of the first and second portion include a user interface. The housing may include a first portion and a second portion that may rotate in relation to each other.

In the following description there is shown and described one possible embodiment of this invention, simply by way of illustration of one of the modes best suited to carry out the invention. As it will be realized, the invention is capable of other different embodiments, and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIGS. 1a and 1b are top and side views of a pill dispenser forming one possible embodiment of the present invention;

FIG. 1c is a partial perspective view of the pill dispenser showing one embodiment of a user interface;

FIG. 2 is a partial exploded view of the device of FIGS. 1a and 1b;

FIG. 3 is a perspective view of a portion of the dispenser shown in FIGS. 1a and 1b;

FIG. 4 is a partial exploded view of a pill dispenser forming one possible embodiment of the present invention;

FIG. 4a is a partial exploded view of one embodiment of a lid and gear;

FIG. 5 is a perspective view of a portion of the dispenser shown in FIG. 4;

FIG. 6 is a partial exploded view of one embodiment a holder, retainer, and barrier;

FIGS. 7a and 7d are exterior views of a pill dispenser forming one possible embodiment of the present invention;

FIGS. 7b and 7c show interior views of the embodiments shown in FIGS. 7a and 7d;

FIGS. 7e, 7f, and 7g are exterior views of a pill dispenser forming one possible embodiment of the present invention;

FIG. 7h shows in the interior view of the embodiment shown in FIGS. 7e, 7f, and 7g;

FIGS. 8a, 8b, and 9 are interior view of embodiments of the present invention;

FIG. 10 is a representative flowchart relating to accessing software;

FIG. 11 is a representative flowchart relating to refilling a dispenser;

FIG. 12 is a representative flowchart relating to programming and software states of the dispenser;

FIG. 13 is a representation of different light patterns representing digits of a Personal Identification Number (PIN).

### DETAILED DESCRIPTION OF THE INVENTION

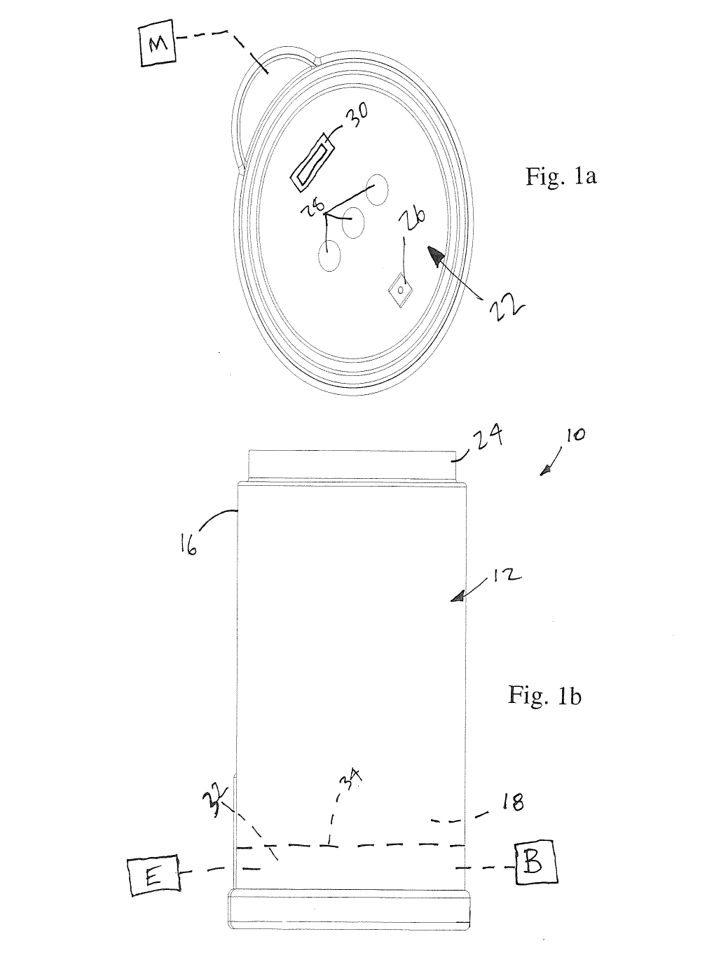

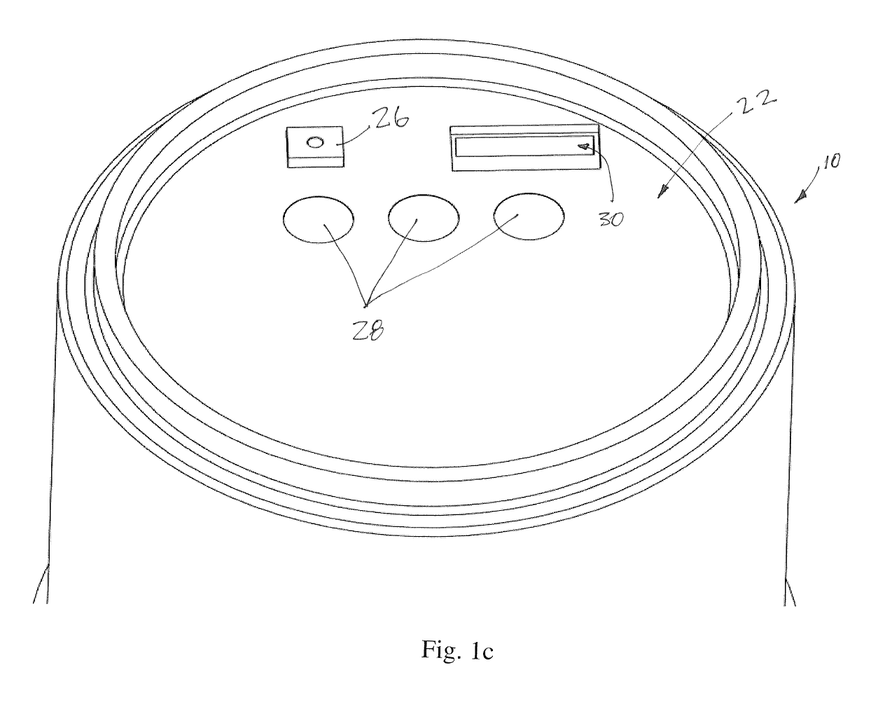

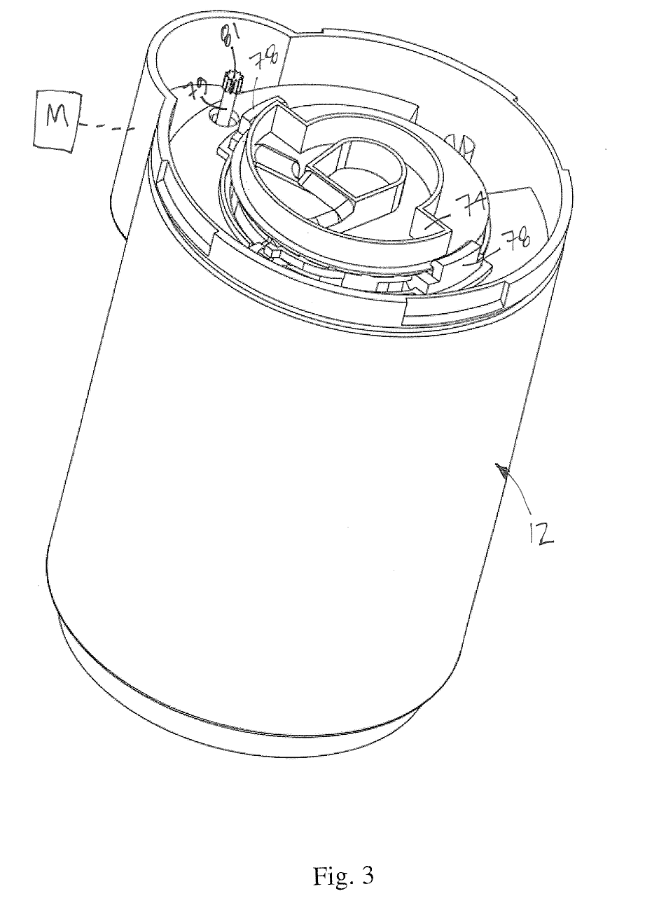

Reference is now made to FIGS. 1a-3 illustrating one embodiment of the pill dispenser 10 of the present invention. In this document, all references to pill(s) relate broadly to all solids, liquids, and gases, regardless of shape, geometry, or size. Additionally, pills may relate to prescription medication, non-prescription medication, or other compositions.

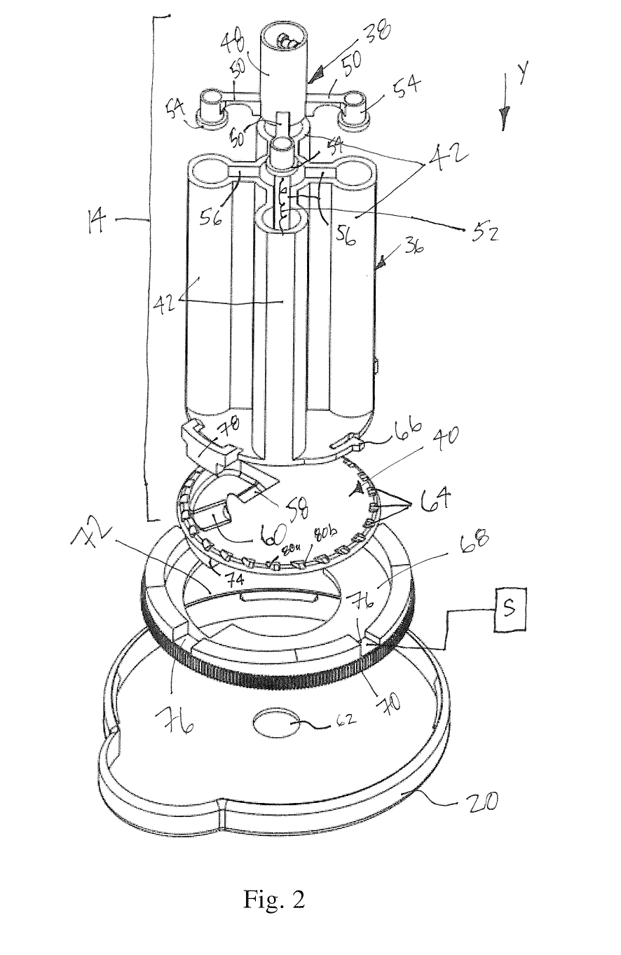

With specific regard to FIGS. 1a, 1b, and 2, the pill dispenser 10 includes a housing 12 and a storage and delivery assembly 14. The housing 12 receives and retains the storage and delivery assembly 14. Interaction between the housing 12 and storage and delivery assembly 14 controls the release of pills from the dispenser 10.

In one embodiment, the housing 12 is a substantially rigid cylinder formed from a durable material, such as polycarbonate or acrylonitrile-butadiene-styrene (ABS). Although any material may form the housing 12, use of a polymer is low cost and less likely to react with other materials or the contents of the housing 12. As shown, the housing 12 includes a substantially uninterrupted sidewall 16 defining a substantially hollow interior 18 adapted to receive at least a portion of the storage and delivery assembly 14. The housing 12 may include a lid 20 that covers the interior 18. The lid 20 may attach by friction or snap fit, adhesive, welding, or any other method for removable or permanent attachment.

In one embodiment, the housing 12 includes a user interface 22 positioned on the side of the housing 12 opposite the lid 20. As shown in FIGS. 1a, 1b and 1c, the user interface 22 may be surrounded by a lip 24 on the housing 12 or otherwise recessed in the housing 12 to minimize the chance of accidental contact with the interface 22. The user interface 22 may include one or more input(s) and/or output(s). In the embodiment shown in FIG. 1a, the interface 22 includes an input button 26 and an output display. In one embodiment, the output display includes three lights 28 that may each illuminate green, yellow, and red. As discussed in greater detail below, various activations of one or more of these lights 28 can provide information to the user and information about the pill dispenser 10. Besides utilizing a plurality of lights 28, the output display may be a single light, a text display, an audio source, a vibrating device for providing tactile feedback to the user, or other device. Some embodiments of the dispenser may display other information or messages via its onboard display, including, but not limited to, number of pills remaining, current time, time of last dispense, time remaining before next available dispense, patient information, prescription information, current geographic location, temperature, or any other information that was programmed into, derived by, or received by the device. Additional embodiments may contain any number of biometric scanning devices, such as fingerprint or retinal scan, in order to authenticate the user.

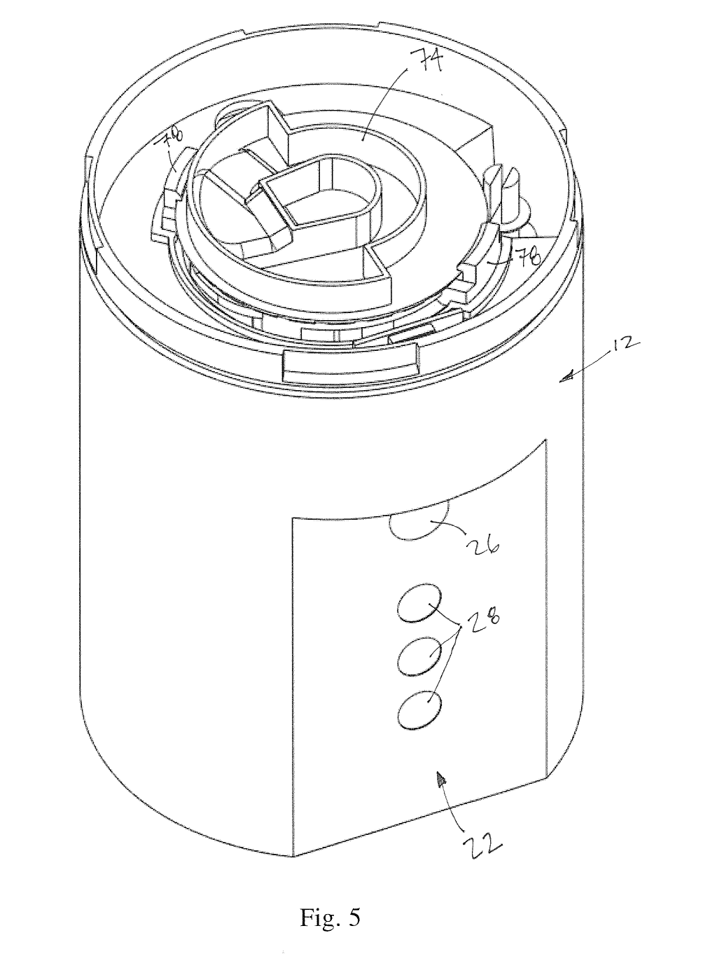

The user interface may also include a workstation computer interface 30 for creating a wire connection between the dispenser 10 and a computer through which a pharmacist or another may access or program the dispenser 10. Although the interface 30 is shown in FIGS. 1a and 1c as being located on the exterior of the housing 12, it may be located anywhere on the dispenser or in communication with the dispenser, such as the interior 18 of the housing 12. When positioning the interface 30 on the interior 18 of the housing 12, the access is substantially limited to the pharmacist or other user. In other words, the interface 30 would be accessible only when the lid 20 is removed. The additional discussion below provides further explanation of the details and use of the user interface 22. Instead of being located on an end of the housing 12, the user interface may be positioned anywhere else on the housing 12. FIG. 5 illustrates an alternative embodiment with the user interface located on the side of the housing.

The housing 12 may include a circuit board and other electronic components to control the mechanical and electrical components of the dispenser 10. For instance, the interior 18 of the housing 12 may include a compartment 32 that contains the electronic components E for the pill dispenser 10. The compartment 32 may be sealed to prevent access by a patient or user. Alternatively, the compartment 32 may be accessible to the user by having the electronic components exposed in the interior 18 of the housing 12 or accessible by removal of a barrier 34, such as a cover or lid. Although the compartment can be located anywhere in the dispenser 10, in one embodiment, the compartment 32 is directly adjacent to the location of the user interface.

One or more batteries B may be retained in the compartment 32 and used to power the electronic components E. The electronic components E may include a sensor to verify that a pill has been dispensed. The electronic components E may also include a physical tamper/intrusion sensor to detect any opening of the container. This may take the form of a sensor built into the lid 20 and/or housing 12 that communicates with the electronics E. The electronics E may also include Global Positioning System (GPS) components for identifying and/or tracking the location of the dispenser. Specifically, GPS can track the location of the dispenser in the case of theft, tampering, or to determine if it is within an unauthorized location, such as in or near the residence of a drug abuser or outside of a medical facility at which the patient should remain. Furthermore, the electronics E may include a cellular transceiver or other wireless communication device for data transfer and communication to/from a central server or other system. This communication could be one-way or two-way. This would allow the pill dispenser 10 to send a signal to a computer system, such as a tracking system, from the computer system to the pill dispenser, or any combination therein.

FIG. 2 illustrates one embodiment of the storage and delivery assembly 14. As shown, the storage and delivery assembly includes a holder 36, a retainer 38, and a barrier 40. The holder 36 comprises at least one reservoir or tube 42 for receiving pills. The retainer 38 is positioned at one end of the holder 36 to vertically retain the pills in place. The other end of the holder 36 includes the barrier 40 that selectively enables release of the pills to a patient.

In the embodiment shown, the holder 36 includes four vertical tubes 42 equally spaced apart in a symmetrical configuration. Having multiple tubes 42 allows for the holder 36 to receive a desired amount of pills without changing the overall length of the pill dispenser 10. For instance, if the pills have a relatively large thickness, one may utilize a holder with a larger number of tubes. Alternatively, if the pills have a relatively small thickness, one may utilize a holder 36 with a smaller number or tubes 42 or even a single tube 42. The tubes 42 may have a diameter sized for a specific type or size of pill to ensure that the pill remains in the column in the desired position.

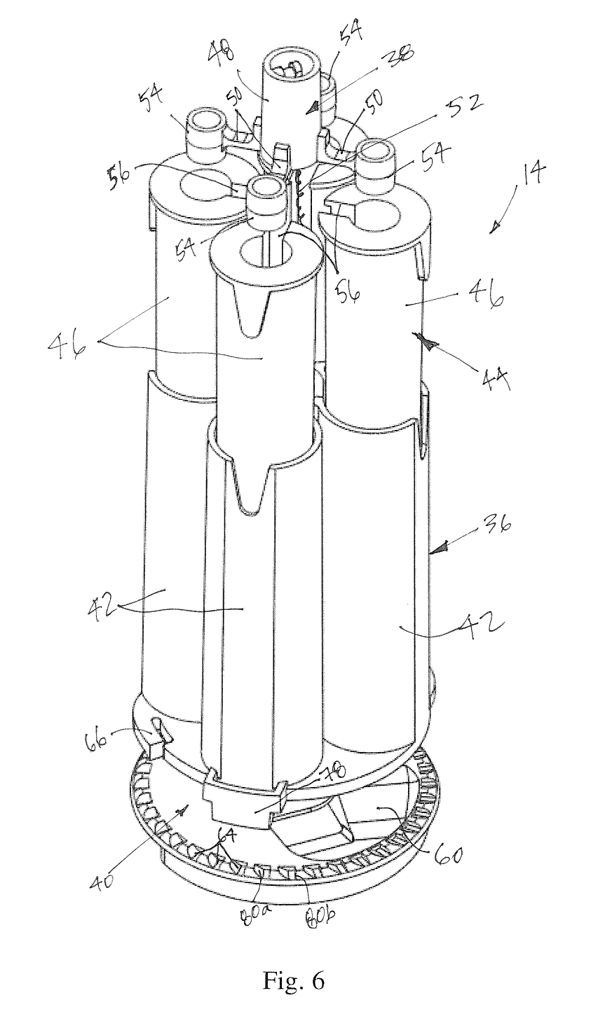

In another embodiment, shown in FIG. 6, the storage and delivery assembly 14 includes a removable insert 44. As shown, the removable insert 44 comprises sleeves 46 or tubes that may be inserted into the holder 36. Accordingly, the outer diameter of the sleeves 46 of the removable insert 44 would preferably be less than the inner diameter of the tubes 42 of the holder 36. The removable insert 44 may be formed in various sizes and shapes to receive various sizes of pills. For instance, sets of sleeves 46 may be formed with each having a separate inner diameter. A user, such as a pharmacist could choose a sleeve 46 or set of sleeves 46 having an inner diameter appropriate for the diameter of pill being prescribed. This allows for a commonly sized holder 36 to be used with multiple sizes of pills. In one embodiment, the number of sleeves 46 of the removable insert 44 corresponds to the number of tubes 42 of the holder 36. Also, the removable insert 44 may be formed as a single piece or multiple pieces that may be inserted into the holder 36.

As mentioned above, at least one retainer 38 vertically retains the pills in the tubes 42. In one embodiment, the retainer 38 comprises a pill compressor, such as a spring-loaded compressor. As shown, the pill compressor includes a cylindrical body 48 with a plurality of arms 50 projecting from the body 48. The cylindrical body 48 is attached to a spring 52 retained on the holder 36 or housing 12. The spring 52 provides tension on the retainer 38 in the direction Y shown in FIG. 2. As shown, the spring 52 is positioned substantially in the center of the holder 36 and the retainer 38. When pills are released (as discussed below in greater detail), the tension of the spring 52 draws the retainer 38 along the length of the tubes 42. This force from the spring 52 on the retainer 38 also serves to force a pill out of a tube 42 when the barrier 40 allows for movement of a pill through the tube 42.

Each of the arms 50 terminates in a substantially cylindrical member 54. Each cylindrical member 54 has a diameter adapted to fit within the tubes 42. In other words, the diameter of each member is substantially equal to or less than the diameter of the tubes 42. As pills are dispensed from the pill dispenser 10, the spring-loaded retainer 38 maintains pressure on the pills in the tubes 42. Note that the retainer 38 is self-levelling in that each arm 50 can flex sufficiently to accommodate the thickness of one pill, such that as a pill is dispensed, the shorter stacks of pills remain in compression as does the taller original height stack of pills. The tubes 42 are interconnected by a series of channels 56 that receive the arms 50 of the retainer 38. This orientation allows for insertion of the retainer 38 as a unit with each arm and/or member in a separate tube 42. In this arrangement, each of the arms 42 and/or cylindrical members 54 engages at least one pill in each separate tube 42.

In one embodiment, shown in FIGS. 2, 4, and 6, the barrier 40 comprises a substantially circular disc including at least one aperture 58 (FIG. 2) to allow for release of at least one pill from the tubes 42. As shown, the barrier 40 includes an angled surface 60 adjacent to the aperture 58. The angled surface 60 serves as a ramp or slide to direct the movement of the pill after it is forced out of a tube 42. The lid of the dispenser may also include an aperture 62 adjacent to the angled surface 60 and aperture 58 of the barrier 40 to allow a user to obtain the pill that has been dispensed. As shown, the barrier 40 may also include a plurality of detents 64 or projections along its edge. When assembled, a portion of the holder 36, such as an arm 66 or projection, may engage one of the detents 36 or projections of the barrier 40.

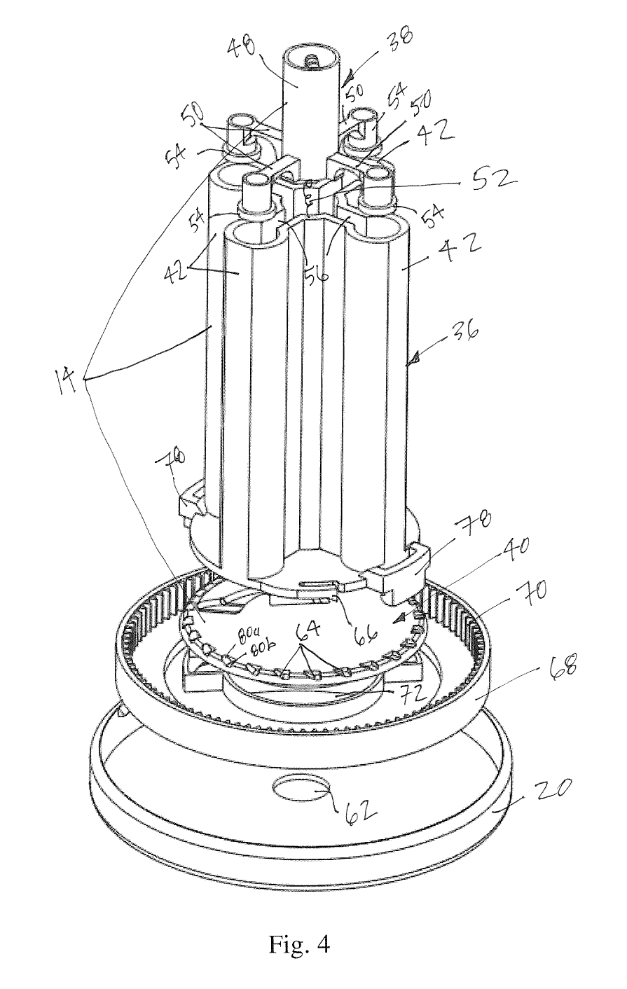

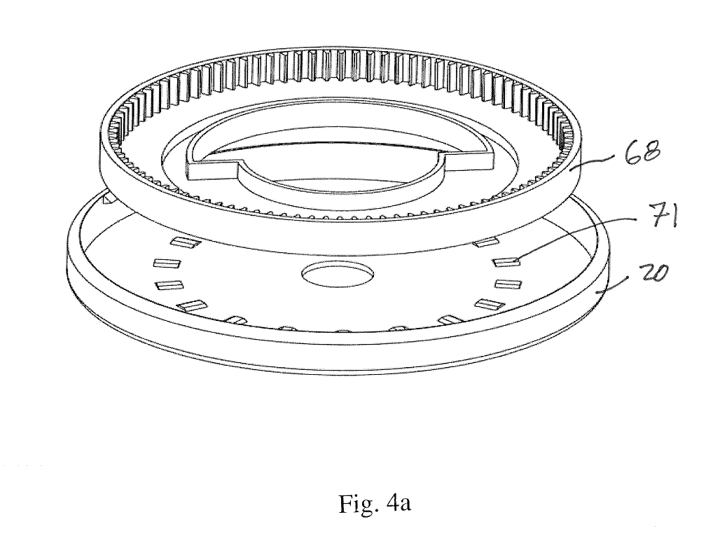

The pill dispenser 10 may also be configured with a gear 68 or plurality of gears to prevent or allow movement of the dispenser components. In one embodiment, the gear 68 comprises an escapement gear having a plurality of gear teeth 70 positioned along an edge of the gear. FIG. 2 shows one embodiment with the gear teeth 70 on an exterior surface of the gear, while FIG. 4 shows another embodiment with the gear teeth 70 on an interior surface of the gear. In the embodiment shown in FIGS. 2 and 4, the gear includes a semi-circular aperture 72 for receiving a portion of the barrier 40. In particular, the barrier 40 may include a projection 74 having shape substantially similar to the shape of the semi-circular aperture 72. Once the projection 74 of the barrier 40 is inserted into the aperture 72 of the gear 68, the movement of the gear 68 causes movement of the barrier 40. An electric motor M may cause movement of the gear. In particular, the electric motor M may engage the gear 68 (such as through a shaft 79 and a gear 81 connected to or otherwise in communication with the motor M). A skilled artisan will appreciate that multiple gears may also be used, such as a gear train that is designed to provide a desired speed and torque. The gear 68 may also include one or more recesses 76 to receive a lock. The lock may take the form of a solenoid S or any other structure that engages the recess 76 and prevents movement of the gear 68.

With regard to assembly and filling of the dispenser 10, the barrier 40 attaches to the holder 36 by engagement of the barrier 40 with one or more clips 78 on the holder 36. The clips retain the barrier 40 against the holder 36, while allowing for the barrier 40 (in this case a disc) to rotate with respect to the holder 36. The clips 78 may be one piece with the holder (such as by molding or forming with the holder) or separate pieces from the holder 36 and barrier 40. The clips 78 also enable contact of the arm 66 of the holder 36 with the detents 64 or projections of the barrier 40. Depending on the shape and configuration of the arm 66 of the holder 36 and/or the detents 64 or projections of the barrier 40, the barrier may be configured for rotation in only one direction or multiple directions. For instance, the detents 64 or projections of the barrier 40 may include a surface 80a having an angle less than 90° and a substantially vertical surface 80b. Upon rotation of the barrier 40 in one direction, the arm 66 of the holder 36 engages the surface 80a having an angle less than 90° and the arm 66 of the holder 36 may move across or over the detent 64 or projection of the barrier 40. Engagement of the arm 66 of the holder 36 with the vertical surface 80b prevents rotation of the barrier 40, as the arm 66 is unable to move across or over the detent 66 or the projection of the barrier.

With regard to assembly of the dispenser 40, in one embodiment, the components of pill dispenser 10 will arrive at a pharmacy, pharmaceutical manufacturer, or other provider of pills in a partially assembled state. Specifically, the housing 12 containing electronics E will be separate from the storage and delivery assembly 14. In one embodiment, the housing 12 is “universal” and can be used with various configurations of storage and delivery assemblies 14. This allows for the provider of the pills, such as a pharmacist, to select various sized storage and delivery assemblies 14 for use with a common housing 12. In other words, the pharmacist would select a specific storage and delivery assembly 14 dependent on the size and shape of the prescribed pills. After selecting the appropriate storage and delivery assembly 14, the pharmacist places the prescribed number of pills in one or more of the tubes 42 of the storage and delivery assembly 14. As previously mentioned, the retainer 38 may attach to the holder 36 by a spring 52. The pharmacist removes the retainer 38 from the holder 36. If the retainer 38 is attached to a spring 52, the user may disconnect the retainer 38 from the spring 52 or leave the spring 52 attached and simply pull the retainer 38 away from the holder. In one embodiment, the retainer 38 may remain attached to the spring 52, pulled away from the holder 36, rotated a desired angle (such as) 90°), and released. This will hold the retainer in a fixed position and allow for filling of the holder 36. When desired (such as after filling), the retainer 38 may be pulled away from the holder 36, rotated so that the retainer is in line with the holder and then released. At this point, the pharmacist may load pills into the holder 36. If there are multiple tubes 42, the user may load pills into each of the tubes 42.

If removable sleeves 46 are used, the pharmacist may select the desired sleeves 46, load them with pills, and then place them in the holder 36. At this point, the retainer 38 may be inserted (by reattachment to the spring 52) or returned to its normal position, as discussed above.

After filling with pills, the retainer 38, holder 36, and barrier 40 are positioned in the housing 12. The housing 12 may be keyed to receive the retainer 38, holder 36, and barrier 40 in only one position. In one embodiment, the housing 12 includes one or more grooves that receive a portion of retainer 38, holder 36, and/or barrier 40. This allows for easy insertion of these components into the housing 12. The gear 68 may then be placed between the barrier 40 and the lid 20. As previously discussed, the aperture 72 of the gear 68 may receive the projection 74. The lid 20 may then be placed on the housing 12, thereby sealing the contents.

As discussed below in greater detail, upon request for a pill from user and authentication of the user (such as by entry of a correct PIN), the barrier 40 may be rotated such that a pill may be released from one of the tubes 42. As the barrier 40 is rotated, the aperture 58 at least partially aligns with the tube 42. Given the pressure on the pills from the retainer 38, the pills will move in the tube 42 and a pill will be released at the aperture 58 of the barrier 40. If the barrier 40 includes the angled surface 60, the pill may be directed toward an auxiliary location, such as the aperture 62 of the lid 20. The spacing of the components in the pill dispenser 10 and/or the amount of force exerted by the retainer 38 enables only a single pill to be released from the holder 36. The amount of rotation of the barrier 40 may be controlled by the electronics E in the housing 12 or the configuration of the mechanical parts (e.g., the barrier and gear) of the dispenser 10. If the dispenser 10 includes a motor M, the motor M may cause the rotation of the gear and the barrier 40, thereby “automatically” dispensing a pill. Alternatively, if a motor M is not present, the patient may manually rotate the lid 20, housing 12, or other portion of the dispenser 10 to dispense a pill. If a solenoid S or lock is present, the electronics E can trigger the release of the solenoid S to allow the movement of the components and the dispensing of a pill. As shown in FIG. 4a, in one embodiment, the lid 20 and gear 68 interface may include a friction coupling such as detents 71, protrusion or interference fit such that the lid may rotate independently from the gear. The lid may rotate when the gear 68 is locked but a pill will not be dispensed, but the friction coupling will be capable of transmitting sufficient torque from the lid 20 to rotate the gear 68 and barrier 40 to dispense a pill when unlocked.

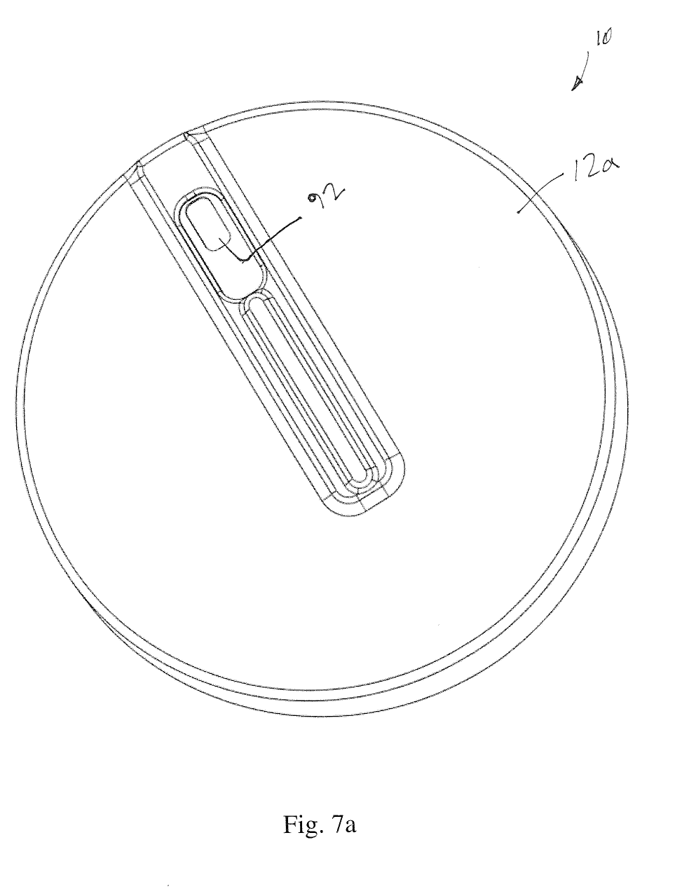

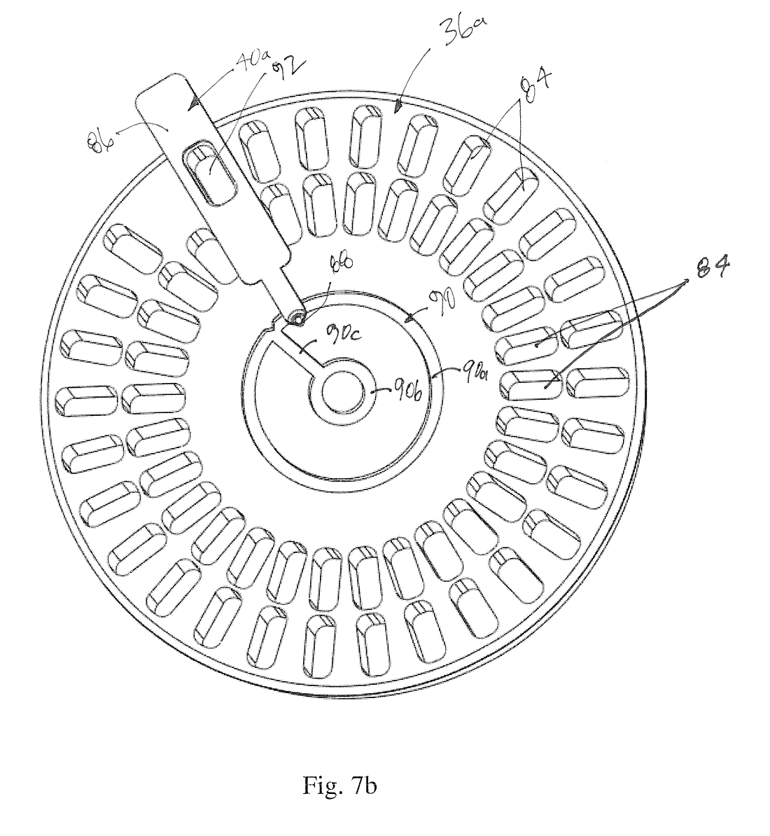

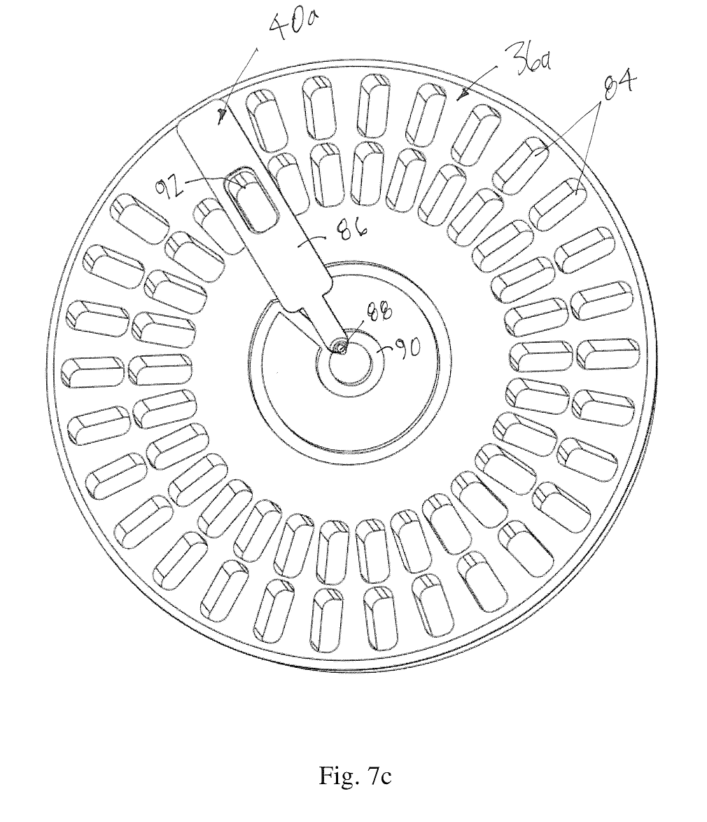

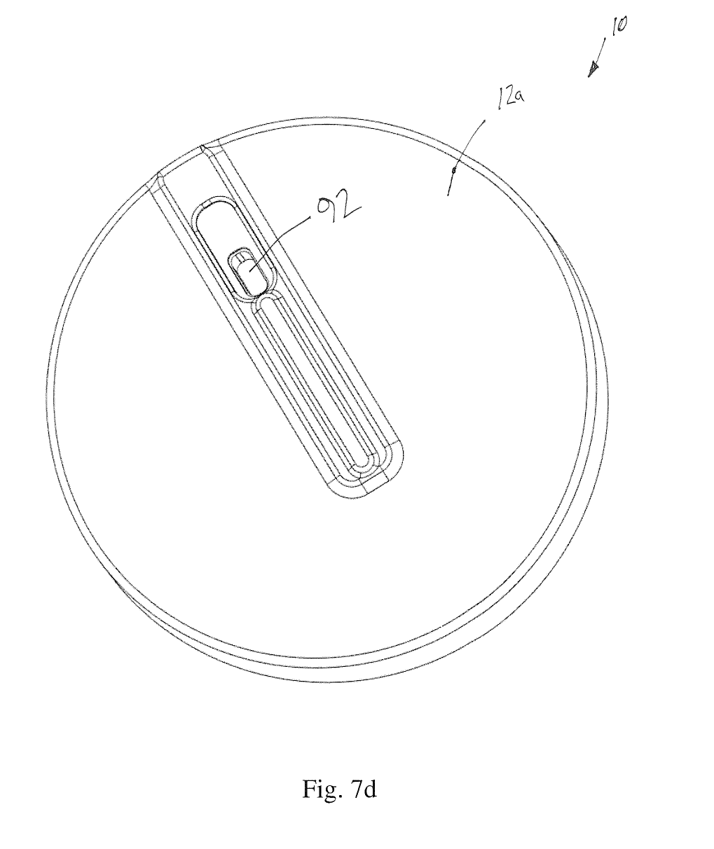

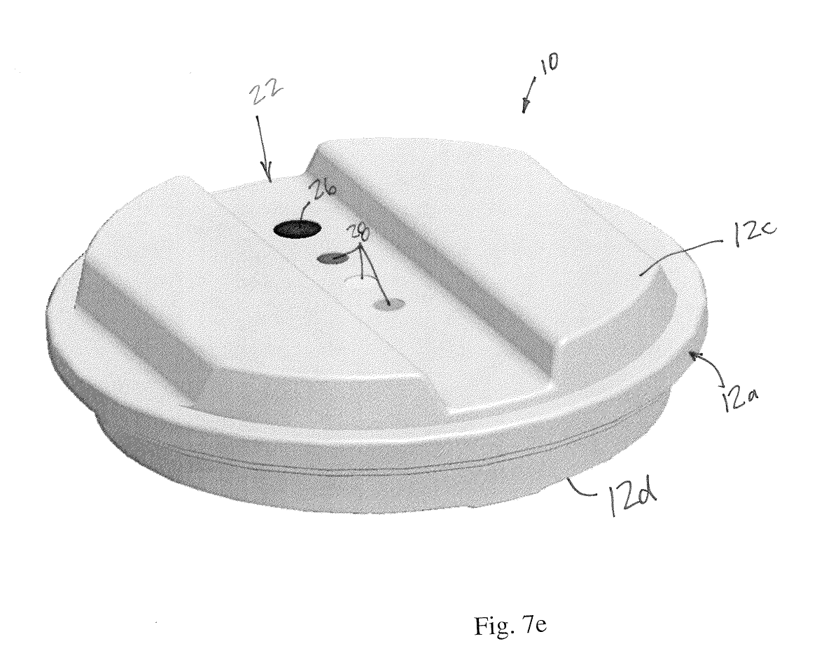

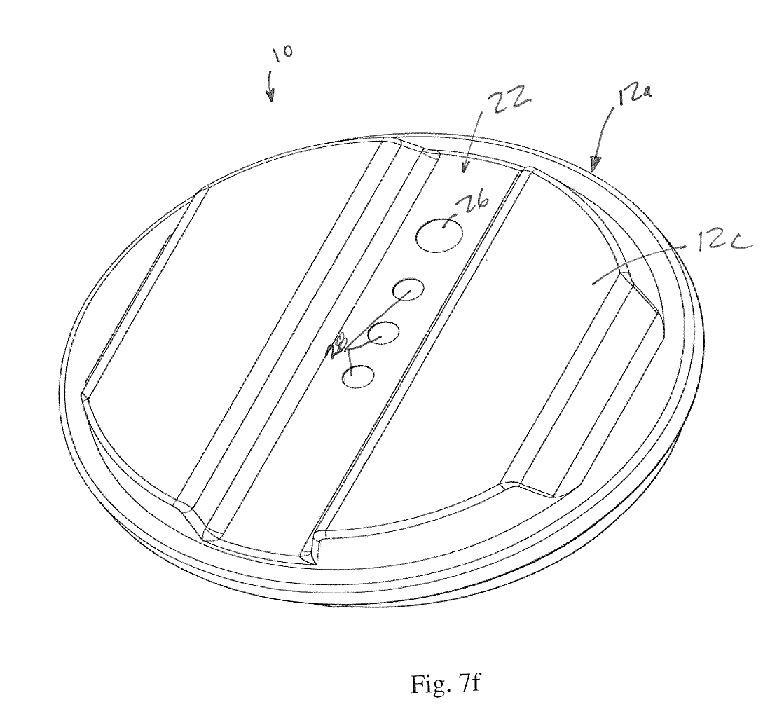

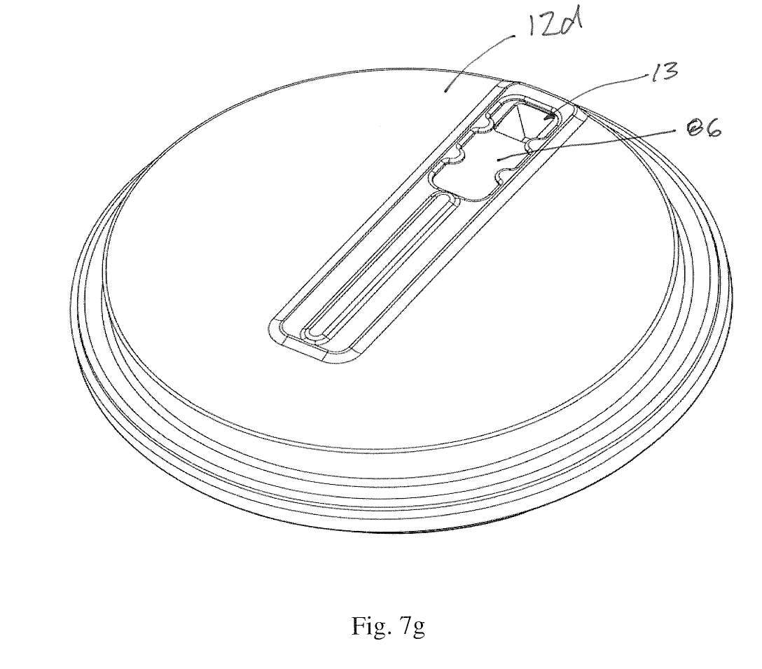

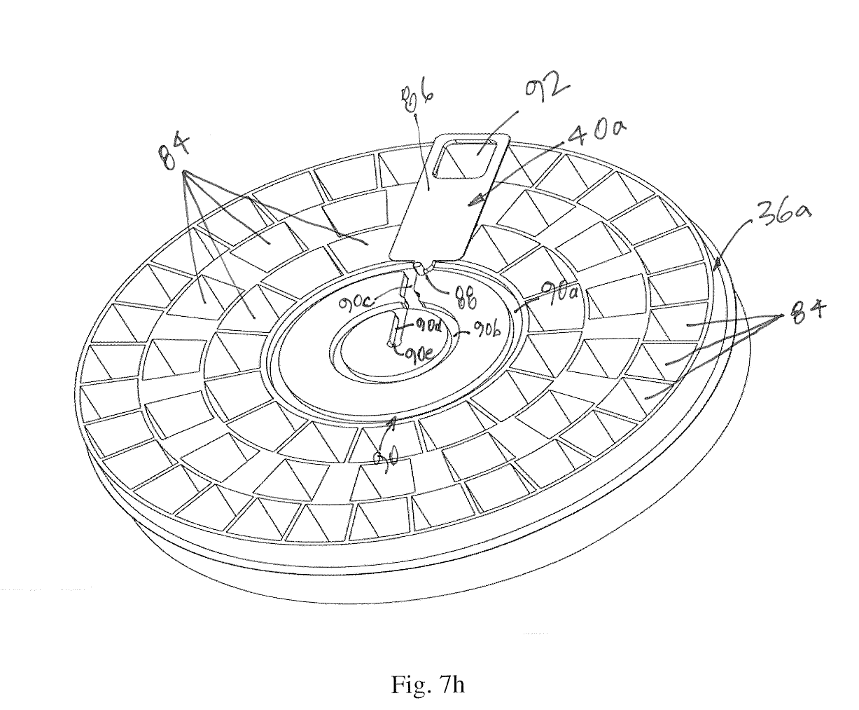

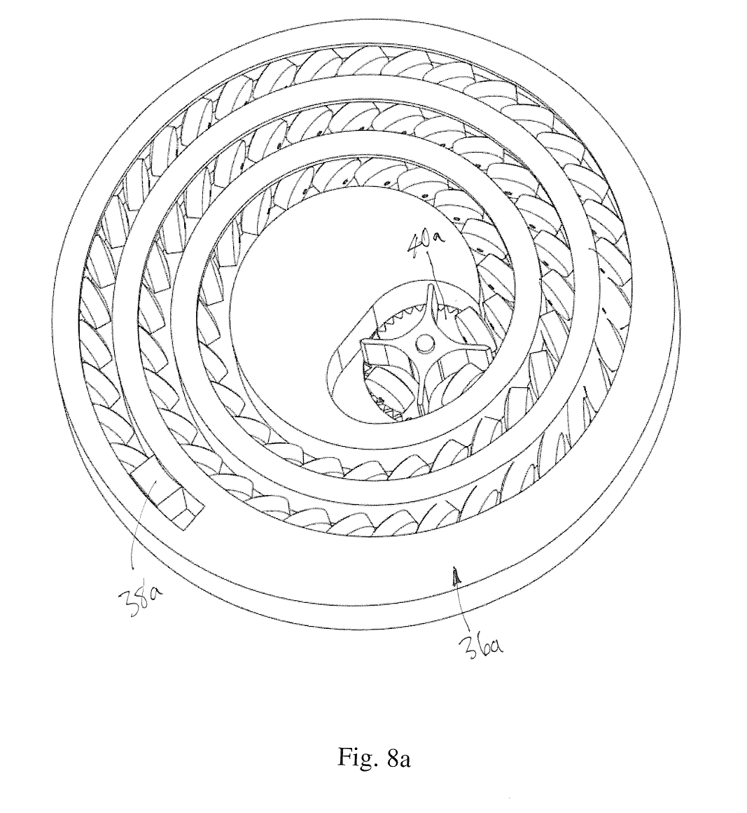

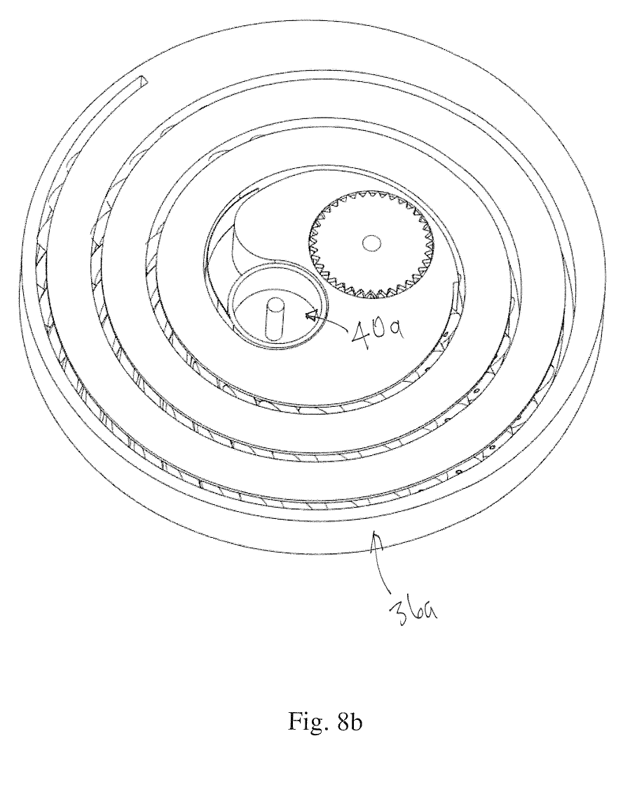

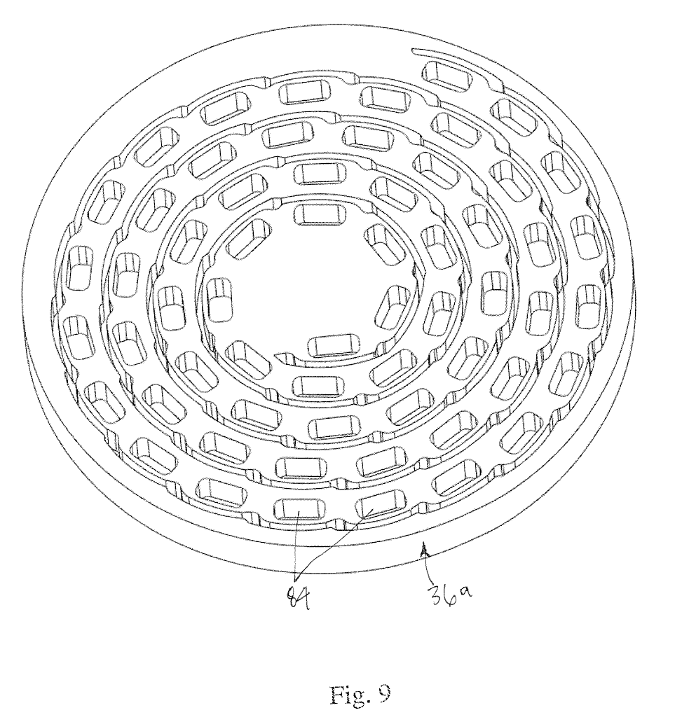

In another embodiment of the pill dispenser 10, the housing 12a is substantially circular and similar to a “clamshell” container (see FIGS. 7a-9). The interior of the housing 12a includes a holder 36a and a barrier 40a. The holder 12a may include a plurality of apertures 84 or recesses for holding the pills. As shown, the holder 36a includes two circular or substantially circular rings of apertures 84; however, the holder may include any number of rings of apertures. Multiple rings allow the pill capacity of the dispenser 10 to be increased. The rings may be concentric or configured in any manner desired. In addition to the circular rings shown, the apertures or recesses may be helical or any pattern (see, e.g., FIGS. 8a-9). The barrier may include a movable arm 86 having a follower 88 that engages a channel 90 or other structure of the holder. In one embodiment, the channel 90 comprises a ring with an outer path 90a and an inner path 90b connected by a linear path 90c. Although shown as circular, the channel 90 may have any shape. As shown in FIG. 7h, the channel 90 may include multiple linear portions, such as the paths 90c, 90d. Also, the center of the path may include a substantially circular region 90e that allows for rotation of the moveable arm 86. FIGS. 7a-7d show how the follower 88 may engage and follow the path of the channel 90. This allows for delivery of the pills from the multiple rows. A solenoid, motor, or other structure may allow or prevent movement of the barrier and follower. Repositioning of an aperture 92 of the barrier 40a enables a pill to be released from the holder. This embodiment of the dispenser may include the electronic components previously discussed. As shown in FIGS. 7e and 7f, a first portion 12c of the housing 12a includes the user interface 22. The user interface may be configured as previously discussed with a user input, such as the input button 26, and/or an output, such as the lights 28. The output 30 may be positioned on the exterior or interior of the housing 12a (FIGS. 7e and 7f) or in any other location in communication with the housing 12a. A second portion 12d of the housing 12a includes an aperture 13 that allows for dispensing or access of a released pill (FIGS. 7e and 7g). In one embodiment, the first portion 12c and second portion 12d are rotatable in relation to each other. For instance, when the solenoid, motor, or other structure allows or prevents movement of the barrier and follower, the first and/or second portion may rotate in relation to each other to allow for a pill to be accessed. In one embodiment, after rotation of the first and/or second portion 12c, 12d, turning the dispenser 10 upside down causes the pill to be released from the aperture 13.

Besides forming the housing and holder as separate pieces, a skilled artisan will appreciate that this embodiment could be one piece. As shown in FIG. 8a, this embodiment may also utilize a retainer 38a, such as a spring loaded pill compressor.

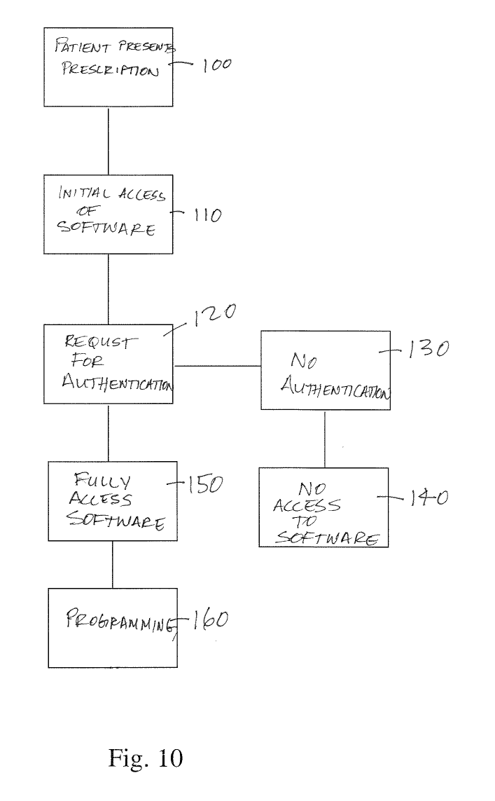

A description of the programming and method of use of the pill dispenser 10 is now provided. In a representative embodiment, shown in FIG. 10, a patient presents a prescription to a pharmacist (step 100). The pharmacist reviews the prescription and initially accesses computer software (step 110) that may interact with the pill dispenser and/or track the patient's actions with respect to their prescriptions. The computer software may be accessed on any type of computer hardware device and may be accessible via a network/server or reside directly on the computer hardware. Moreover, the software may be accessed on a computer specifically dedicated to use with the pill dispenser 10. Also, the software may be a plug-in or interface with other software programs, online interfaces, or any other means of interfacing software components. This would enable the software to be used with other programs presently installed at a pharmacy. To access the software, the pharmacist will be required to provide authentication (step 120). This may require the entry of a password or other input from the pharmacist. If the authentication fails (step 130), then the pharmacist will not have full access to the software (step 140).

After authentication, the pharmacist may fully access the software (step 150), enter data relating to the patient and prescription, and the dispenser 10 may be programmed (step 160). The patient information may include the patient's name, address, phone number, a patient ID, and/or any other information needed to identify the patient. The patient information may be stored in a database of patients at the local pharmacy or it may be stored in a database covering a wider region. For instance, the data may be stored in a centralized and/or distributed database accessible to a group of pharmacies or locations. The software and/or database may also be able to interface with other prescription databases to gather prescription information from multiple sources. For example, the software and/or database may be able to access or otherwise interact with a state's controlled substance tracking system.

After entering the identifying information, the software may display any past prescription information for the patient. This includes the prescribed dispensing schedule for previous prescriptions. This may also include any other prescriptions utilizing a pill dispenser 10 that the patient may already have, along with any other prescriptions, including those for narcotics. If required for filling the current prescription, this allows the pharmacist to verify that all outstanding pill dispensers from this patient have been returned. The pharmacist may also verify that the patient does not have other outstanding narcotic prescriptions at other pharmacies by accessing a controlled substance tracking system.

At this point, the pharmacist enters the current prescription information into the software and connects a pill dispenser 10 so that it may communicate with the software. The connection of the pill dispenser 10 may be a direct, physical connection via a Universal Serial Bus (USB), RS232, or other wire connected between the housing and a computer. Alternatively, the connection between the pill dispenser 10 and the software may be wireless or any other method that enables communication between the software and the pill dispenser. Once connected, the software may program the pill dispenser 10 by communicating with the electronics E. This may include providing the dispense rate for the dispenser 10 and any other desired information. The software may also generate a unique access code or PIN for the prescription. This access code may be a sequence of numbers, colors, or other symbols that the patient may use to request a pill from the dispenser. The software may be used to print the access code or PIN on a card for the patient's future reference.

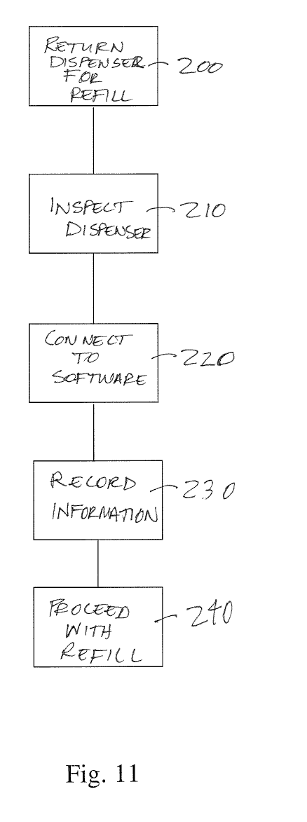

As shown in FIG. 11, patients with expired prescriptions or who would like to get a prescription refilled may return their pill dispenser 10 to a pharmacist (step 200) or other provider to get a new prescription. The pharmacist first visually checks the pill dispenser 10 for evidence of tampering (step 210) and records the condition of the pill dispenser device with the software. The pharmacist then connects the returned pill dispenser 10 to the software (step 220), either via wire or wireless manner, as discussed above. In one embodiment, the pharmacist removes the lid 20 of the dispenser 10 to access the interface 30 and connect a wire from the interface 30 to a computer. The dispenser software downloads information stored in the dispenser (step 230). The software then verifies that the prescription information matches the information in its database. If the information in the pill dispenser does not match the database, the pharmacist can investigate why or turn the matter over to the authorities. In addition to current and historical prescription information, the software can download key press history, dispensing history, tampering detection information, and/or other usage data from dispenser. Drug addiction researchers and biostatisticians may analyze this usage data to gather information on patient behavior, which may lead to discovery of a pattern that indicates addictive behavior and ultimately prevent addiction. Patterns of behavior that can be linked to, or indicate the likelihood of leading to, addiction may be identified. New information such as this may be shared with scientists and other workers in the drug abuse area as well as with health care workers so that early warning signs of addiction can be discovered. At this point, the pharmacist can proceed to refill the prescription (step 240) and program the dispenser 10 in the manner discussed above. For convenience, the software may provide shortcuts to entering new prescription information if the prescription of the patient returning the dispenser is entitled to refill.

In one embodiment, the pill dispenser automatically reports its state through a cellular or other wireless network to save the patient the trouble of returning the dispenser, provide faster response to tampering, or report other issues. Some embodiments of the device may include an electronic tamper sensor. Such a sensor could be in the form of a wire mesh, a mesh of printed conductors, or a serpentine wire pattern, embedded anywhere between the outside of the dispenser 10 and the pills themselves. Upon detection of tampering, the dispenser may report the tampering to a third party or network. This reporting may be done wirelessly or in any desired manner.

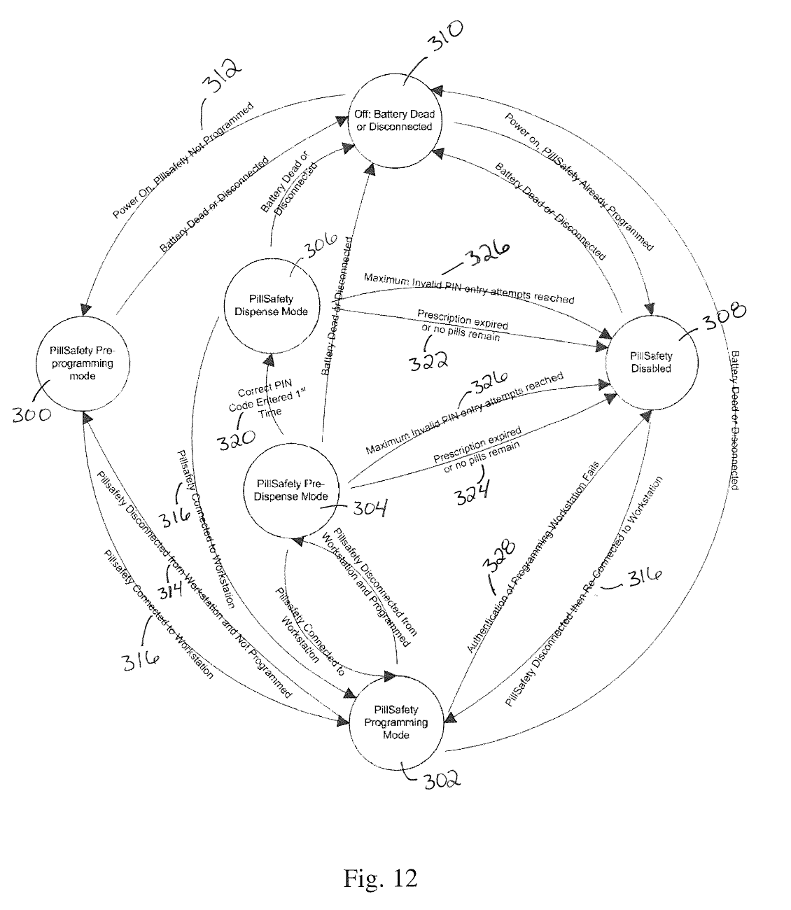

Although the pill dispenser may be programmed to operate in any desired mode, in one embodiment shown in FIG. 12, the pill dispenser may operate in one of five distinct modes: (1) pre-programming mode 300; (2) programming mode 302; (3) pre-dispense mode 304; (4) dispense mode 306; and (5) disabled mode 308. Depending on the status of the dispenser, the pills, and actions taken by the user/pharmacist/patient, the dispenser may transition from one mode to another. Although not a specific programming mode, the dispenser may also transition to an “off” state 310, such as when the battery is dead.

The pre-programming mode 300 is the default state of the pill dispenser 10, wherein a pharmacist or other has not programmed the dispenser (step 312) and the dispenser 10 is not attached to a workstation of the dispenser software (step 314). When an empty dispenser 10 is shipped from a manufacturer to a pharmacy or other location for filling, it will be in the pre-programming mode 300. In the pre-programming mode 300, the dispenser 10 will not respond to requests for a pill by depressing or otherwise activating the user input, such as the input button 26. In one embodiment, the pre-programming mode may provide output via the lights 28 of the user interface 22. For instance, a light 28 may illuminate green then yellow then red to indicate that the dispenser is not programmed. A blinking yellow light may illuminate to indicate that the battery is low.

Once connected to the dispenser software (step 316), the dispenser will transition to the programming mode 302. The programming mode 302 enables a user to program the dispenser with a specific dispensing schedule for the pills that will be stored in the dispenser, a “beyond use” date, an expiration date, patient identification information, time of day, date, access code or any combination therein. In the event that authentication by the dispenser software fails, the pill dispenser will transition to the disabled mode discussed below.

The dispensing schedule corresponds to the prescription provided by the medical professional. For instance, if a medication is prescribed for a patient to take once every 4 hours, the pharmacist may input this in the software and the dispenser will be programmed to dispense once every 4 hours. The dispenser may also calculate the amount of time since it was programmed. The dispenser may be programmed to not dispense a pill until after a programmed time has passed since the time the dispenser was programmed. The expiration date corresponds to the end date for a particular prescription. If the prescription is for 30 days, then the expiration date may be set for this time period or another desired period (e.g., 35 days to provide a buffer to the user if they do not begin the medicine immediately). The “beyond-use” date may also be entered into the dispenser 10 in the case where there is NO prescription expiration date. The “beyond-use” date may be a date after which the maximum effectiveness of the drug is reduced. Upon arriving at either of these two programmed dates, the dispenser will no longer dispense any pills. In particular, the dispenser software communicates with the dispenser to program it. The user-defined parameters may be stored in memory of the pill dispenser. The pharmacist may also specify a “begin date” before which no pills will be dispensed. The “begin date” may be useful for prescriptions requiring more pills than will fit in one device. The excess pills can be dispensed in a device with a “begin date” set after the user should complete using all the pills in the first device.

Besides the foregoing parameters, other parameters may be programmed, as well. For instance, the pharmacist may specify a specific PIN number for the dispenser. Alternatively, the dispenser software may randomly generate a PIN. The PIN will be stored in memory located on the dispenser and may be accessible by a pharmacist upon connecting the dispenser to the dispenser software. If a user should forget the PIN for the dispenser, the pharmacist would be able to access it via the dispenser software and provide it to the patient. Also, the PIN may be stored in the database for the dispenser software, if desired.

One or more “emergency” PINs may be provided to the patient to enable one or a small number of additional pills to be taken outside the normal schedule, in case a pill is lost, for example by being dropped in the drain of a sink or some other inaccessible place. The emergency PIN could be for a single-use or limited multiple-use. The emergency PIN could be given either when the device is issued to the patient or at a later time, only if needed. If issued at a later time, it could be issued in person, by phone, text message, or through other means of communication by a person or some automated system. After issuing an emergency PIN, the entity issuing subsequent emergency PIN's might require more substantiation of hardship from the patient. Furthermore, the emergency PIN(s) could be programmed remotely through an optional on-board wireless transceiver, or networked connected base station.

Similar to the pre-programming mode, the dispenser will not respond to requests for a pill by depressing or otherwise activating the user input, such as the input button, when in the programming mode. When the dispenser is disconnected from the dispenser software, if the pill dispenser has been programmed, the pill dispenser will transition to the pre-dispense mode. Alternatively, if the dispenser has not been programmed, it will transition to the pre-programming mode. In one embodiment, the programming mode may provide output via the user interface. For instance, a green light may illuminate to indicate that the dispenser is connected to a workstation and/or the dispenser software. Also, a fast green blinking light may indicate that the dispenser is actively being read by the workstation and/or dispenser software. Similarly, a fast blinking red light may indicate that the dispenser is actively being programmed by the workstation and/or dispenser software. A blinking yellow may indicate that the battery is low.

The dispenser will enter and remain in the pre-dispense mode 304 after being programmed, disconnected from the dispenser software (step 318), and prior to input of a correct PIN. In this mode, the dispenser 10 will wait for a request for a pill made by depressing or otherwise activating the user input; however, the dispenser will not dispense a pill. Once the dispenser receives a correct PIN, it will transition to the dispense mode. In the event a “beyond use” date has passed, the prescription has expired, a maximum number of consecutive invalid PIN entry attempts have been reached, a critically low battery, or physical tampering has been detected, the dispenser will transition to the disabled mode. Similar to the other modes, in one embodiment, the pre-dispense mode may provide output via the lights of the user interface. For instance, a slowly blinking green light may indicate that the dispenser is waiting for a first PIN code entry. This first PIN code entry may be a master code that is common to a particular pharmacy or may be the PIN code that is provided to the patient. A yellow light may illuminate on while the input button is pressed to acknowledge user activation of the input button for less than five seconds, such as when entering a PIN. A green light may illuminate on for five seconds to indicate that the correct PIN has been received and that the dispenser is transitioning to the dispense mode. A blinking yellow may indicate that the battery is low. Also, a red blinking light may indicate that the prescription has expired or that the dispenser is disabled. A red light blinking quickly for three seconds may indicate that the PIN code was incorrect or that the input button was pressed for more than five seconds.

After the dispenser has been programmed, and it is not connected to the dispenser software, and after it has received a correct PIN for the first time (step 320), it will transition into the dispense mode 306. If a pill is available to be dispensed (dependent on the prescribed dispensing schedule), the user interface may provide output to the patient, such as a slowly blinking green light. After the patient has been authenticated by entry of a correct PIN through a user input, such as the input button, the dispenser will dispense a pill. In the event a “beyond use” date has passed, the prescription has expired, a maximum number of consecutive invalid PIN entry attempts have been reached, or physical tampering has been detected, the dispenser will transition to the disabled mode. The pill dispenser may also be programmed to transition to the disabled mode if the dispenser detects a specific user behavior, such as excessive activation of the user input, or entry of a PIN at an interval more frequent than allowed by the prescribed interval. This behavior may be indicative of addictive or abusive behavior. In one embodiment, the dispensing mode may provide output via the lights of the user interface. For instance, a green light blinking slowly may indicate that a pill is available. When the green light goes off, a pill is not available. Alternatively, the dispenser may not provide an indication to a patient that a pill is available. This may be beneficial in gathering behavior information regarding potential signs of addiction. A yellow light may illuminate while the input button is pressed to acknowledge user activation of the input button for less than five seconds, such as when entering a PIN. A green light may illuminate for five seconds to indicate that the correct PIN has been received and the dispenser may dispense a pill, automatically or otherwise. A green light blinking for ¼ second intervals may indicate that the dispenser is repeating a single digit of the PIN code back to the user. A blinking yellow light may indicate that the battery is low. Also, a red light blinking slowly may indicate that the prescription is expired or the dispenser is disabled. A red light blinking quickly for three seconds may indicate that the PIN code is incorrect or the input button was pressed for more than five seconds.

As mentioned above, the pill dispenser will enter into the disabled mode 308 if any of the following conditions occur: (1) no pills remain in the dispenser (step 322); (2) the prescription has expired (step 324); (3) the maximum number of consecutive invalid PIN entry attempts has been reached (step 326); (4) authentication of the dispenser software fails (step 328); (5) physical tampering has been detected; (6) if the dispenser detects addictive or abusive behavior (e.g., a correct PIN is entered, but much more often than the prescribed dispensing interval, or excessive activation of the user input); (7) if the pill dispenser enters an unauthorized physical location, as determined by GPS locating; (8) if the device has been unable to establish communication with a tracking system through a wireless transceiver; (9) if the device is directed to transition to the disabled mode by instructions from a remote system, such as a drug tracking system. In the disabled mode, the pill dispenser will not respond to input activation by a user and will not dispense pills. In one embodiment, the disabled mode may provide output via the lights 28 of the user interface 22. For instance, a red blinking light may indicate that the dispenser has been disabled. A yellow blinking light may indicate that the battery is low.

Although the output of single lights 28 have been discussed with the various modes of operation, any form of output may be provided to the user in each mode. For instance, a plurality of lights may be illuminated, sounds may be emitted, text may be displayed, or otherwise.

If the electronics determine that it is an appropriate time for dispensing a pill (e.g., the programmed amount of time has passed since the last pill was dispensed), then the dispenser 10 will release a pill after the user has been authenticated. In one embodiment, the user is authenticated by entry of a personal identification number (PIN). As previously discussed, a unique PIN is provided to the user for a specific prescription and pill dispenser 10. Although the PIN may be any number or configuration of numbers, in one embodiment, the PIN comprises a four digit number with each digit in the range of 1 to 5. For example, the PIN may be 2345 or 5321, but it may not be 2146.

To enter a PIN and request a pill from the dispenser 10, a user will take the following action. Assuming that the dispenser 10 is ready to dispense a pill (e.g., the appropriate amount of time has passed since the last pill was dispensed), the user will enter the first digit of the PIN. Utilizing the user interface 22 shown in FIGS. 1a and 5, the user will press the button 26 the number of times corresponding to the first digit of the pin. If the first digit is the number one, the user will press the button 26 once. If the first digit is the number five, the user will press the button 26 five times. To acknowledge the button press, one of the lights 28 of the display will stay on or be activated while the button is pressed. If more than two seconds of time passes between button presses, the dispenser 10 will register the number of times the button has been pressed and “lock-in” the number of button presses as a digit. In one embodiment, one of the lights 28 of the display will blink a number of times equal to the “locked-in” digit. For example, if the user presses the button 26 three consecutive times and then stops, one of the lights 28 on the user interface 22 will blink three times in a regular interval (e.g., ¼ second interval of time) to indicate that the number three was the “locked-in” digit. If the button 26 is held for an extended period of time, such as for more than five seconds during input of a digit, or if the dispenser 10 receives more than five consecutive presses (therein indicating a digit greater than five), the dispenser 10 may reset the digit, or alternately cancel the PIN entry, and the user may start again. One of the lights 28 of the user interface 22 may flash to indicate to the user that the digit has been reset and that he or she needs to begin again with the entry of the first digit of the PIN. Also, if more than 10 seconds passes from the time the last digit was “locked-in,” the dispenser 10 may display an error in the form of a blinking light and require the user to begin again with entry of the first digit. These steps for entry of the first digit of the PIN are the same for entry of the second, third, and fourth digits of the PIN. For example, after the user presses the button 26 the number of times corresponding to the first digit, he or she waits for approximately 2-9 seconds. At that point the user may enter the second digit and wait again for approximately 2-9 seconds. The third and fourth d g is are also entered in this same manner of button pressing and waiting. As previously mentioned, if the dispenser 10 is configured to provide a confirmation of the PIN digit entries, one of the lights 28 of the display may flash in the waiting period to confirm the digit entered by the user. After all four digits of the PIN have been entered, the electronics of the dispenser 10 will compare the entered PIN to the one stored in memory. If these numbers match, then the dispenser 10 will indicate that a valid PIN has been received. This indication may be the illumination of a light 28 on the display. At this point, the dispenser 10 may transition to the dispense mode and a pill may be provided to the user.

If the PIN is invalid, the dispenser 10 will indicate this to the user by displaying a light 28 on the user interface 22. The electronics of the dispenser 10 will also record that an invalid PIN has been received. If the next entry of the user is the correct PIN, the dispenser 10 will indicate this to the user and proceed with transitioning to the dispense mode and a pill may be provided to the user. At this point, the electronics of the dispenser 10 may reset a count for the number of consecutive invalid PINs received to zero. However, if the subsequent entry from the user is another incorrect PIN, then the electronics dispenser 10 will record that another invalid PIN has been received. If the number of consecutive invalid entries reaches a maximum number (as programmed in the dispenser 10), then the dispenser 10 will transition to the disabled mode.

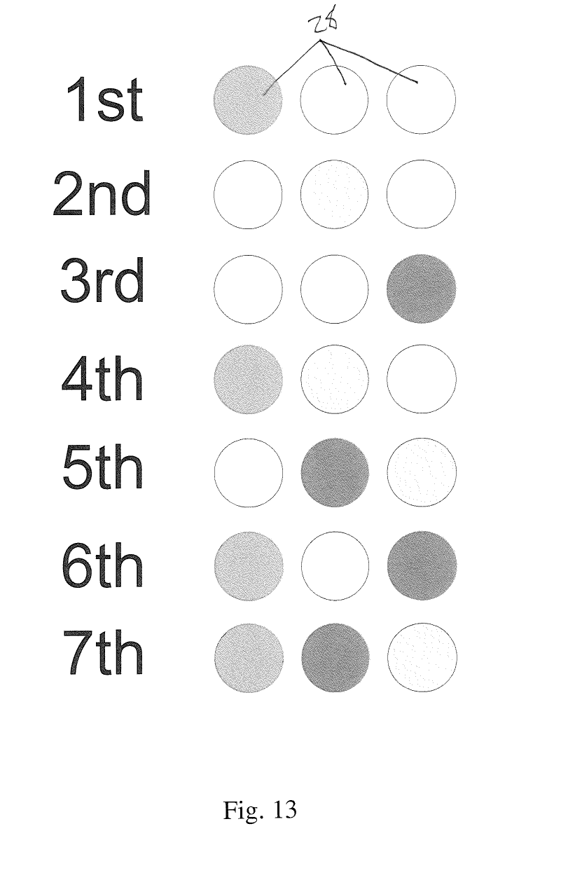

In another embodiment, the user may input the PIN by associating each digit of the PIN with a different pattern of lights on the user interface 22. Although the lights 28 may be any color, in one embodiment, each digit is represented by a combination of light patterns consisting of green, red, and yellow. To advance from one digit pattern to the next, the user holds down the input button 26. Starting at the 1^{st} pattern in FIG. 13, the lights will cycle through the digit patterns by illuminating the pattern for 1 second, turning off all lights for ½ second, then illuminating the second pattern for 1 second, and so on until it has cycled through all 7 available patterns. FIG. 13 illustrates one pattern for each digit of the PIN, listed in the order they will occur (i.e., in sequence). Somewhat similar to the previous embodiment, to enter a PIN and request a pill from the dispenser 10, a user will take the following action. Assuming that the dispenser 10 is ready to dispense a pill (e.g., the appropriate amount of time has passed since the last pill was dispensed), the user will enter the first digit of the PIN. To enter the digit, the user holds the input button 26 until the pattern representing the first digit of PIN appears, then release the button 26. This will “lock-in” the digit. If the button 26 is held through the entire sequence of all 7 patterns, the lights will repeat the patterns starting at the 1^{st}. If the button 26 is held long enough for the lights to repeat the sequence of patterns 3 times, the user interface 22 will display an error (red then yellow, repeat for 5 seconds) and the user may begin again. Also, if more than 10 seconds pass from the time the last digit was “locked-in,” this will display an error (red then yellow, repeat for 5 seconds) and the user may begin again. These steps are repeated for the entry of the second, third, and fourth digits. The comparison and logging of PINs will then proceed as discussed with the previous embodiment.

In alternate embodiments, the user is authenticated by entry of a PIN on alphanumeric keypad or display, an audio signal (such as voice recognition), biometric scanner, accelerometer, or any other input.

The foregoing descriptions of various embodiments of the invention are provided for purposes of illustration, and are not intended to be exhaustive or limiting. Modifications or variations are also possible in light of the above teachings. For example, the dispenser 10 may be filled and assembled at a pharmaceutical manufacturer, mail order pharmacy, or other and sent directly to a patient or other party. The housing may be any shape and formed of any material. Moreover, the components of the dispenser 10 may be combined or formed in any number of parts desired. The dispenser 10 may be reusable or could be disposable after a single use. Also, the user input may take the form of a touch sensor, fingerprint reader, digital camera, or otherwise. The software may be configured for facial recognition, gesture recognition, to recognize bar codes or other authentication tokens. The input may be conveyed by a network, such as a personal area network (e.g., BLUETOOTH), a wireless local area network, a cellular network, or other. The output of the user interface may be a liquid crystal display (LCD), a pixel-based display (including one based on LCD, LED, or “electronic ink” technology). The output may also be conveyed by a network, such as a personal area network (e.g., BLUETOOTH), a wireless local area network, a cellular network, or other. Also, the dispenser 10 may be fitted with a unique identification label, such as a serial number, RFID tag, tamper proof sticker, barcode, or other. These labels may be configured to not be altered without the tampering being apparent. The dispenser may also be configured to dispense a pill once it receives a permission signal over a wireless link or other communication method. In one embodiment, a permission signal must be received before each pill is released from the dispenser 10.

Also, in one embodiment, the signal must have been received by the dispenser 10 within a predetermined time before a pill will be released. The dispenser 10 may be configured to receive a revocation signal over the wireless link or other communication method. This may serve to revoke a permission signal previously provided. The dispenser 10 may also be configured to dispense pills without electronics. The embodiments described above were chosen to provide the best application to thereby enable one of ordinary skill in the art to utilize the disclosed inventions in various embodiments and with various modifications as are suited to the particular use contemplated. All such modifications and variations are within the scope of the invention.

1. A pill dispenser, comprising:
a housing defining an interior;
a plurality of holders for receiving a plurality of pills;
a movable barrier positioned at one end of the holder; and
a retainer capable of moving at least one of the pills in the holder;
wherein at least a portion of the holder and barrier are positioned within the interior of the housing.

2. The pill dispenser of claim 1, wherein the retainer is connected to a spring and alignment of an aperture of the barrier enables the movement of a pill from the holder.

3. The pill dispenser of claim 1, wherein the retainer is self-leveling and includes at least one flexible arm.

4. The pill dispenser of claim 1, further comprising a gear wherein the barrier engages a portion of the gear.

5. The pill dispenser of claim 4, wherein rotation of the gear causes rotation of the barrier.

6. The pill dispenser of claim 5, further comprising a motor for moving the gear.

7. The pill dispenser of claim 2, wherein the barrier includes an angled surface for directing the movement of a pill after it exits the holder.

8. The pill dispenser of claim 1, wherein the barrier includes a disc with a plurality of detents and the holder includes a projection that interacts with at least one of the detents to control movement of the disc.

9. The pill dispenser of claim 4, further comprising a friction coupling between a lid and the gear to allow movement of the lid independent from the gear.

10. The pill dispenser of claim 1, further comprising a user interface with at least one input and one output.

11. The pill dispenser of claim 9, wherein at least one input is a button.

12. The pill dispenser of claim 9, wherein at least one output is a plurality of lights.

13. A pill dispenser, comprising:
a housing defining an interior;
a holder including at least one tube for receiving a plurality of pills;
a rotatable disc having at least one aperture positioned at one end of the holder; and
a pill compressor that is capable of moving at least one of the pills in the at least one tube;
wherein at least a portion of the holder and barrier are positioned within the interior of the housing and movement of the disc enables release of a pill from the at least one tube.

14. The pill dispenser of claim 13, further comprising a gear wherein the rotatable engages a portion of the gear.

15. The pill dispenser of claim 14, wherein the gear includes a plurality of teeth on an outer surface and the dispenser further includes a motor that engages at least a portion of the plurality of teeth.

16. The pill dispenser of claim 13, wherein the holder includes a plurality of symmetrically positioned tubes.

17. The pill dispenser of claim 16, wherein the pill compressor includes a plurality of arms to match the number of tubes.

18. The pill dispenser of claim 17, wherein the plurality of arms are flexible thereby self-leveling the pill compressor.

19. The pill dispenser of claim 17, wherein each of the arms includes a cylindrical member.

20. The pill dispenser of claim 13, wherein a spring retains the pill compressor to the holder.

21. The pill dispenser of claim 13, wherein the dispenser includes a lid having at least one aperture.

22. The pill dispenser of claim 21, wherein the rotatable disc includes an angled surface that is capable of directing a pill to the at least one aperture of the lid.

23. The pill dispenser of claim 13, wherein the rotatable disc includes a plurality of detents or projections.

24. The pill dispenser of claim 23, wherein the holder includes a projection that interacts with at least one of the detents or projections to control movement of the disc.

25. The pill dispenser of claim 14, further comprising a friction coupling between a lid and the gear to allow movement of lid independent from the gear.

26. The pill dispenser of claim 13, further comprising a user interface with at least one input and one output.

27. The pill dispenser of claim 25, wherein at least one input is a button.

28. The pill dispenser of claim 25, wherein the at least one output is a plurality of lights.

29. A method of filling a pill dispenser, comprising:
accessing a software program;
entering data relating to a prescription;
connecting the pill dispenser with the software;
programming the pill dispenser with data;
placing pills in the pill dispenser.

30. The method hod of claim 29, wherein the method of filling further comprises sealing the pill dispenser.

31. The method of claim 29, wherein the accessing a software program requires user authentication to fully access the software program.

32. The method of claim 29, wherein the programming the pill dispenser comprises storing a dispensing schedule.

33. The method of claim 29, wherein the connecting comprises physically connecting the pill dispenser to a computer by a wire.

34. A method of dispensing pills, comprising:
determining if it is an appropriate time for dispensing a pill;
authenticating the user in possession of a pill dispenser;
dispensing a pill from the pill dispenser, if the user is authenticated and it is an appropriate time for dispensing the pill.

35. The method of claim 34, wherein the authenticating requires the user to enter a PIN.

36. The method of claim 35, wherein the pill dispenser further compares the entered PIN to a PIN stored in the memory of the pill dispenser.

37. The method of claim 34, wherein the determining if it is an appropriate time for dispensing a pill comprises determining if a programmed amount of time has passed since a previous pill was dispensed.

38. The method of claim 34, wherein the determining if it is an appropriate time for dispensing a pill comprises determining if a programmed amount of time has passed since the device was programmed.

39. The method of claim 34, wherein the determining if it is an appropriate time for dispensing a pill comprises determining if the device is undamaged.

40. The method of claim 34, further comprising the step of detecting tampering with the pill dispenser.

41. A pill dispenser, comprising:
a housing, defining an interior;
a holder including a plurality of recesses for holding pills; and
a movable barrier having an aperture that enables a pill to be released from the holder.

42. The pill dispenser of claim 41, wherein the holder includes a plurality of rings of apertures.

43. The pill dispenser of claim 41, wherein the holder includes a channel and the moveable barrier includes a follower that engages the channel.

44. The pill dispenser of claim 41, wherein the housing includes a first portion and a second portion and one of the first and second portion include a user interface.

45. The pill dispenser of claim 41, wherein the housing includes a first portion and a second portion that may rotate in relation to each other.
